(19) United States
(12) Patent Application Publication
(10) Pub. No.: US 2010/0310743 A1
(43) Pub. Date: Dec. 9, 2010

(54) REMOVING GAS ADDITIVES FROM RAW MILK

(75) Inventors: Ray S. McCoy, Southlake, TX (US); Mark A. Hilton, Heath, TX (US); Shaun W. Young, Royse City, TX (US)

Correspondence Address: BAKER BOTTS L.L.P., 2001 ROSS AVENUE, SUITE 600, DALLAS, TX, 75201-2980, US

(73) Assignee: Dean Intellectual Property Services, Inc., Dallas, TX (US)

(21) Appl. No.: 12/765,378

(22) Filed: Apr. 22, 2010

Related U.S. Application Data
(60) Provisional application No. 61/184,244, filed on Jun. 4, 2009.

(51) Int. Cl. A23C 3/02; B65B 31/02; B65B 55/14; A23C 1/00

(52) U.S. Cl. 426/397; 426/520; 426/522; 426/404; 99/454

(57) ABSTRACT

According to one embodiment of the present invention, a mixture including milk and one or more gas additives is received at a milk processing system. The system heats the mixture and directs it toward an inlet to be delivered into a vacuum chamber. The vacuum chamber applies a negative vacuum pressure to the mixture to substantially remove the added gas. The resulting milk is extracted from the vacuum chamber.

### RELATED APPLICATION

This application claims the benefit of priority under 35 U.S.C. §119(e) of U.S. Provisional Application Ser. No. 61/184,244, filed Jun. 4, 2009, and entitled “REMOVING CARBON DIOXIDE ADDITIVES FROM RAW MILK.”

### TECHNICAL FIELD

This invention relates generally to the field of milk processing and more specifically to removing gas additives from gas treated milk using vacuum pressure.

### BACKGROUND

Raw milk may contain microorganisms, such as psychrotrophic pathogens, psychrotrophic spoilage microbes, and deleterious enzymes. Microorganism growth may occur over time and may reduce the safety and quality of the raw milk. As a result, the storage life of the raw milk may be relatively short.

Adding carbon dioxide (CO₂) to the raw milk may reduce the growth rate of the microorganisms, thereby increasing the storage life of the raw milk and allowing it to be shipped over long distances. For example, U.S. Patent Application Publication No. 2005/0260309 discloses “Extended Shelf Life and Bulk Transport of Perishable Organic Liquids with Low Pressure Carbon Dioxide.” The CO₂ may be removed prior to processing the raw milk into a finished product. Removal of the added CO₂ may be required for the Food and Drug Administration (FDA) to approve the use of CO₂ as a raw milk additive.

### SUMMARY OF THE DISCLOSURE

According to one embodiment of the present invention, a mixture including milk and one or more gas additives is received at a milk processing system. The system heats the mixture and directs it toward an inlet to be delivered into a vacuum chamber. The vacuum chamber applies a negative vacuum pressure to the mixture to substantially remove the added gas. The resulting milk is extracted from the vacuum chamber.

Certain embodiments of the invention may provide one or more technical advantages. A technical advantage of one embodiment may be that a gas removal system may be included in a commercial milk processing system. For example, certain embodiments may scale the removal system to remove gas from commercial volumes of milk. As another example, certain embodiments may remove the gas from a continuous flow of milk.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a gas injection system for generating gas treated milk;

FIG. 2 illustrates an example of a system for removing gas additives from gas treated milk;

FIGS. 3a-3c illustrate examples of nozzles that may be used to expose a large surface area of gas treated milk to a negative vacuum pressure; and

FIGS. 4a-4b illustrate examples of the placement of an inlet port within a vacuum chamber.

### DETAILED DESCRIPTION OF THE DRAWINGS

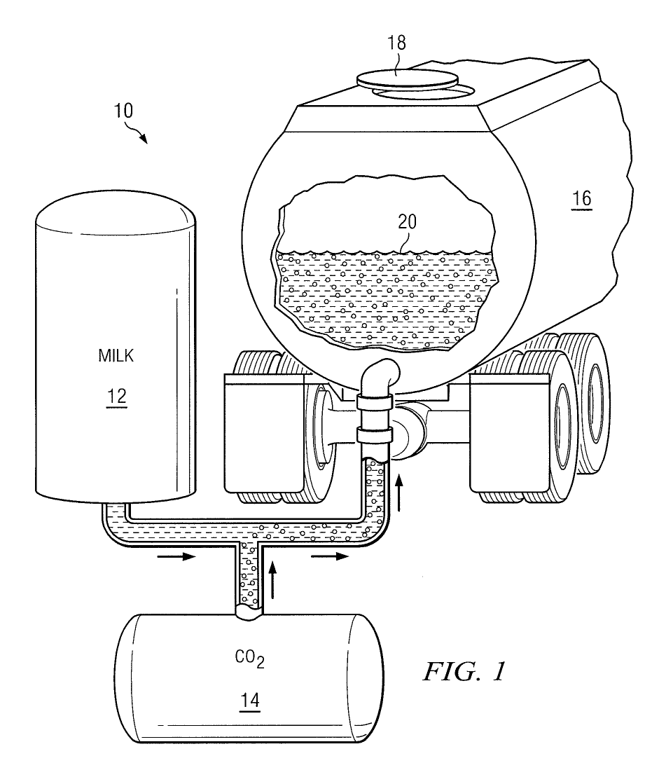

Embodiments of the present invention and its advantages are best understood by referring to FIGS. 1-4 of the drawings, like numerals being used for like and corresponding parts of the various drawings.

One or more gases may be added to raw milk to extend the storage life of raw milk and to allow for shipping raw milk over long distances. The gas additives may be removed prior to processing the raw milk into a finished product. Removal of the added gas may be required for the Food and Drug Administration (FDA) to approve the use of gas as a raw milk additive.

Known systems may add carbon dioxide to milk. These known systems may remove the added carbon dioxide from small batches of milk that are processed statically, that is, one batch at a time. Known systems, however, may be unable to achieve the amount of carbon dioxide removal that may be required by commercial milk processing applications. In accordance with the present invention, disadvantages and problems associated with known techniques for removing added carbon dioxide from milk may be reduced or eliminated. For example, certain embodiments may be scaled to remove carbon dioxide from a commercial sized system. As another example, certain embodiments may remove carbon dioxide from a dynamic, continuous flow of milk.

FIG. 1 illustrates an example of a gas injection system for adding gas to raw milk to form a mixture, however, any system for adding gas to raw milk may be used. Examples of gases that may be added to the raw milk include carbon dioxide, nitrogen, carbon monoxide, sulfur dioxide, ozone, hydrogen, and/or a combination, for example, carbon dioxide. A gas injection system may include a raw milk source 12, a carbon dioxide source 14, and a vessel 16. In some embodiments, the raw milk source 12 may direct raw milk to the vessel 16. Prior to adding the carbon dioxide, the raw milk may have a pH of approximately 6.6 and a carbon dioxide concentration of approximately 10-400 parts per million (ppm), such as 80-100 ppm. The temperature of the raw milk may be less than approximately 45° F. In some embodiments, the carbon dioxide source 14 may direct carbon dioxide gas to the vessel 16. The flow rate of the carbon dioxide gas may be determined based on the flow rate of the raw milk into the vessel 16 and the concentration of carbon dioxide to be achieved in the mixture.

The vessel 16 may include a pressure relief valve 18, and may hold gas treated milk 20. In some embodiments, the head pressure of the vessel 16 may be approximately zero pounds per square inch gauge (psig) prior to receiving the gas treated milk 20. The vessel 16 may be filled by pumping raw milk from the raw milk source 12 and carbon dioxide from the carbon dioxide source 14 into the vessel 16. In some embodiments, the amount of carbon dioxide pumped by the carbon dioxide source 14 may be selected to achieve a concentration of 1700-2800 ppm of carbon dioxide in the gas treated milk 20, such as 2100 to 2400 ppm. The resulting pH may range from approximately 5.9 to 6.2. The carbon dioxide and raw milk may be pumped into the vessel 16 with or without head pressure. In some embodiments, a head pressure of approximately 25 psig or less may be maintained while filling the vessel 16. The pressure relief valve 18 may release air as needed to maintain the head pressure. Once the vessel 16 has been substantially filled with the gas treated milk 20, the pressure relief valve 18 may be opened to allow the head pressure to decompress. In some embodiments, the vessel 16 may be resealed when the head pressure is approximately equal to 0 psig.

In some embodiments, the filled vessel 16 may be shipped to a milk processing location. During storage and/or shipment, the gas treated milk 20 may have a temperature less than approximately 45° F. In some embodiments, the gas treated milk 20 may maintain its microbial integrity for greater than 72 hours. For example, milk treated with carbon dioxide may maintain its microbial integrity for approximately ten days. Maintaining the microbial integrity of the raw milk for longer periods of time may allow for shipping over relatively long distances, such as across North America. In some embodiments, the carbon dioxide may be removed from the gas treated milk 20 at the milk processing location. Although the example has been described in the context of carbon dioxide, similar techniques may be used to add other gases to milk.

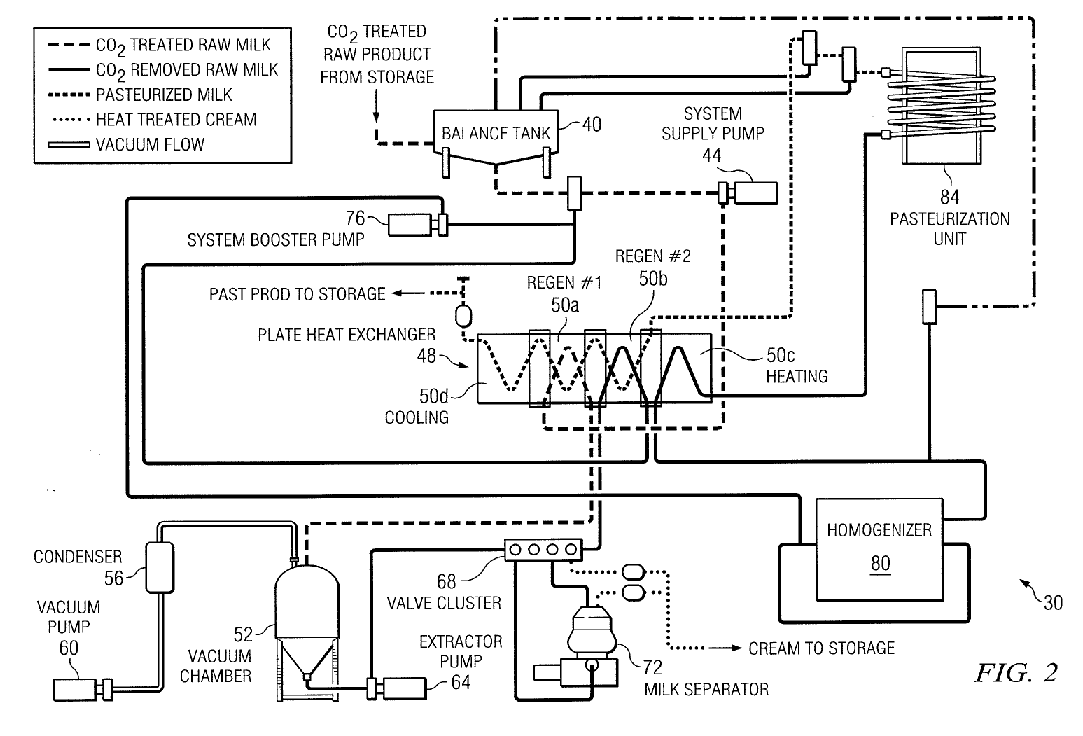

FIG. 2 illustrates an example of a system 30 for removing added gas from gas treated milk. The system 30 may be any suitable milk processing system. In some embodiments, system 30 may comprise a heat exchange system, such as a high temperature/short time (HTST) system, an extended shelf life (ESL) system, an ultra-high temperature (UHT) system, a higher heat/shorter time (HHST) system, or a “bulk” or “batch” pasteurization system. As an example, HTST embodiments of the system 30 may include a balance tank 40, a system supply pump 44, a plate heat exchanger 48, a vacuum chamber 52, a condenser 56, a vacuum pump 60, an extractor pump 64, a valve cluster 68, a milk separator 72, a system booster pump 76, a homogenizer 80, a pasteurization unit 84, a storage element, and/or other suitable elements.

According to some embodiments, gas treated milk may be directed from storage to the system 30. The gas treated milk may enter the system 30 at a balance tank 40 that supplies constant levels of milk to the other elements. From the balance tank 40, the gas treated milk may flow to a system supply pump 44, where the pressure at which milk moves through the system 30 may be controlled. The gas treated milk may continue to a heater, such as plate heat exchanger 48.

According to some embodiments, the plate heat exchanger 48 may control the temperature of the milk. The plate heat exchanger 48 may comprise multiple sections 50, such as a first regeneration section 50a, a second regeneration section 50b, a heating section 50c, and a cooling section 50d. Each section 50 of the plate heat exchanger 48 may control the temperature of the milk at different points in the treatment process. For example, the gas treated milk received from the system supply pump 44 may be received at section 50a of the plate heat exchanger 48 to be heated using regenerative heating. Regenerative heating may transfer heat from the pasteurized milk exiting the system 30 to the incoming gas treated milk. Thus, the amount of energy required to heat the cold gas treated milk and to cool the outgoing pasteurized milk may be reduced. In some embodiments, the gas treated milk may be heated to a temperature in the range of approximately 130° F. to 175° F., such as 130° F. to 165° F.

Upon exiting the section 50a, the gas treated milk may be directed to a vacuum chamber 52. In some embodiments, the gas treated milk may enter the vacuum chamber 52 at a continuous flow, with a flow rate in the range of approximately 30-150 gallons per minute, such as 60 gallons per minute. In some embodiments, a nozzle may deliver a stream of milk to the vacuum chamber 52. The nozzle may shape the stream to expose a large surface area of milk to vacuum pressure. Exposing the gas treated milk to vacuum pressure may remove the added gas. For example, the gas concentration may be reduced to a level similar to that of raw milk to which gas has not been added. As an example, in embodiments using added carbon dioxide, the vacuum pressure may reduce the carbon dioxide level to less than approximately 400 ppm. In addition to removing the added gas, the vacuum pressure may remove volatile compounds from the milk that may be associated with the type of feed ingested by the livestock that supplied the milk.

According to some embodiments, vacuum pressure may be generated in the vacuum chamber using a vacuum pump 60. The negative pressure of the vacuum may range from approximately 20 to 28 inches of mercury (Hg), such as 24 inches Hg. In some embodiments, a condenser 56 may cool the milk vapors removed from the vacuum chamber 52 to condense them from gaseous form to liquid form. Any suitable condenser may be used, such as a shell and tube heat exchanger. A shell and tube heat exchanger may include an outer shell with a bundle of tubes inside it. Hot milk vapors may enter the shell side and flow over the tubes while a cooling liquid, such as cold water, runs through the tubes to cool the milk vapors in order to yield a liquid. The liquid formed by cooling the milk vapors may then be removed from the system 30.

Once the added gas has been substantially removed, the raw milk may be extracted from the vacuum chamber 52 and sent to the next elements for further processing. For example, an extractor pump 64 may pump the raw milk from the vacuum chamber 52 to a valve cluster 68. The valve cluster 68 may send raw milk to a milk separator 72 or to the plate heat exchanger 48. The milk separator 72 may separate the raw milk into cream and skim milk. For example, the milk separator 72 may rapidly rotate the milk to generate centrifugal forces that may separate the milk. As the skim milk leaves the milk separator 72, it may be returned to the valve cluster 68. As the cream leaves the milk separator 72, it may be directed out of the system 30 for storage or returned to the valve cluster 68 to be recombined with the skim milk. The amount of recombined cream may be selected to form a certain type of milk, such as 1% milk, 2% milk, or whole milk.

The valve cluster 68 may send the raw skim or recombined milk from the milk separator 72 to the plate heat exchanger 48. Alternatively, the valve cluster 68 may send raw milk directly from the extractor pump 64 to the plate heat exchanger 48, bypassing the milk separator 72. In some embodiments, the valve cluster 68 may send the raw milk to be heated by the second regeneration section 50b of the plate heat exchanger 48. The heated raw milk may be directed from the plate heat exchanger 48 to a homogenizer 80. In some embodiments, system 30 may include a system booster pump 76 to ensure the raw milk flows to the homogenizer 80 at a proper pressure.

The homogenizer 80 may process the raw milk so that the cream and skim portions are evenly dispersed throughout. Homogenization may prevent or delay the natural separation of the cream portion from the skim portion of the milk. In some embodiments, the raw milk may be homogenized by forcing it through a restricted orifice at approximately 1800 pounds per square inch. The process may shear the raw milk particles thereby allowing for even dispersion throughout the milk.

According to some embodiments, the homogenized milk from the homogenizer 80 may be diverted to the balance tank 40, or may continue on to the plate heat exchanger 48. The milk may be diverted to the balance tank 40 to facilitate a recovery in the event system 30 shuts down abruptly. For example, the balance tank 40 may re-circulate the milk through the system 30 if the amount of new milk received is not adequate to supply the system 30. Upon a determination that the homogenized milk need not be diverted, the milk may continue to the heating section 50c of the plate heat exchanger to be heated for pasteurization.

The heating section 50c may heat the raw milk to pasteurization temperature using temperature controlled hot water. In some embodiments, the heating section 50c may heat the raw milk to a temperature in the range of approximately 160° F. to 165° F. The heated raw milk may be sent to a pasteurization unit 84.

In some embodiments the pasteurization unit 84 may be a hold tube and flow diversion unit. The flow rate of the raw milk through the tube may be selected based on the dimensions of the tube to ensure the raw milk is exposed to pasteurization temperatures for enough time to achieve pasteurization, such as 15 to 30 seconds. If the pasteurization requirements are not met, the milk may be diverted to the balance tank 40 to be re-circulated through the processing system. If pasteurization is successful, the pasteurized (finished) milk may be returned to the plate heat exchanger 48 to be cooled in the cooling section 50d. The cooling section 50d may allow heat to transfer from the hot pasteurized milk to chilled glycol or water. Upon reaching a storage temperature, such as 35° F., the pasteurized milk exits system 30 and is sent to post production storage. The pasteurized milk may have storage life similar to pasteurized milk that has not been treated with gas, such as approximately three weeks.

Modifications, additions, or omissions may be made to system 30 without departing from the scope of the invention. The components of system 30 may be integrated or separated. Moreover, the operations of system 30 may be performed by more, fewer, or other components. Additionally, operations of system 30 may be performed in any suitable order using any suitable element. As used in this document, “each” refers to each member of a set or each member of a subset of a set.

According to some embodiments, the milk processing system may be configured to remove adequate amounts of gas from the gas treated milk. Configurable settings may include the initial concentration of the gas in the milk, the temperature of the milk, the flow rate of the milk into the vacuum chamber, the negative pressure in the vacuum chamber, and the surface area of the milk exposed to the vacuum pressure. The following values are provided for example purposes, however, any suitable values may be used. In some embodiments, the concentration of the gas in the gas treated milk may range from approximately 1700-2800 ppm. The temperature of the milk received in the vacuum chamber may range from approximately 130° F. to 175° F., such as 130° F. to 165° F. The flow rate of the milk entering the vacuum chamber may range from approximately 30-150 gallons per minute, such as 60 gallons per minute. The negative vacuum pressure may range from approximately 20 to 28 inches Hg, such as 24 inches Hg. The surface area may be selected to expose a relatively large surface area to the negative vacuum pressure.

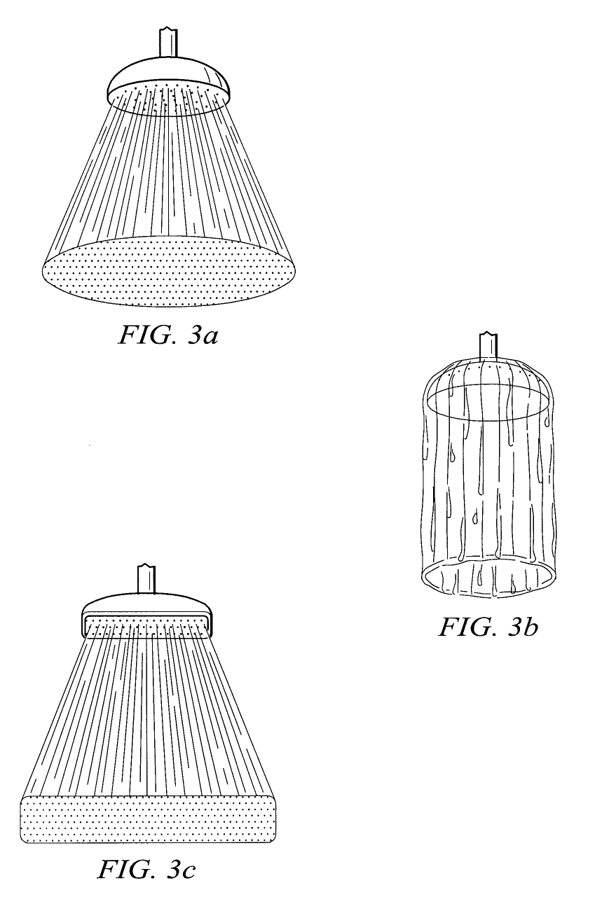

FIGS. 3a-3c illustrate examples of nozzles that may direct gas treated milk to a vacuum chamber, such as the vacuum chamber 52 of FIG. 2. The example nozzles may expose a large surface area of gas treated milk to negative vacuum pressure by dispersing the milk as it flows into the vacuum chamber. The nozzle of FIG. 3a may be substantially round and may include many apertures. The apertures may be angled away from the center of the nozzle such that a stream of milk exits the nozzle substantially in a cone shape. In some embodiments, the cone may be substantially hollow. The nozzle of FIG. 3b may include a convex portion over which milk may be poured. The milk may run down the convex portion of the nozzle and into the vacuum chamber in a parabolic or umbrella shaped stream. The nozzle of FIG. 3c may be generally rectangular and may generate a fan-shaped stream of milk. While certain nozzles have been described, any nozzle that exposes a large surface area of gas treated milk to negative vacuum pressure may be used. Some nozzles may expose a very large surface area to the vacuum pressure and may result in moisture loss. For example, atomizers may release milk in a fine mist that exposes a very large surface area to the vacuum pressure. Using these types of nozzles may require moisture restoration during milk processing.

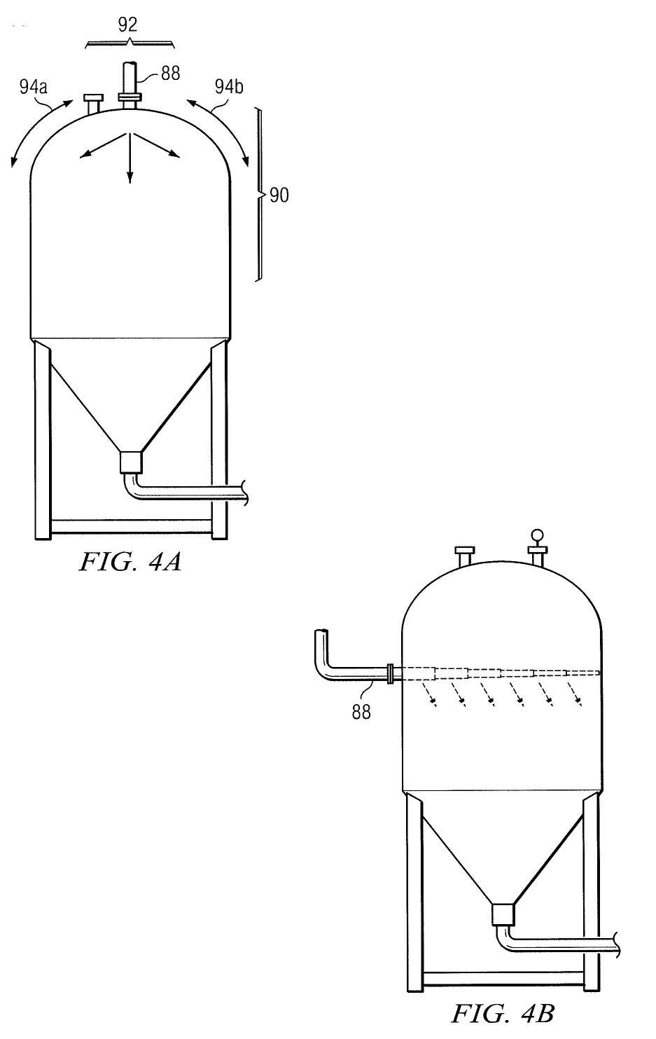

FIGS. 4a-4b illustrate examples of the placement of an inlet port 88 of a vacuum chamber, such as the vacuum chamber 52 of FIG. 2. In some embodiments, the inlet port 88 may direct the mixture into the vacuum chamber. The inlet port 88 may be located in any suitable position. In some embodiments, the inlet port 88 may be located in a top portion 90 of the vacuum chamber, such as approximately the top one-third of the vacuum chamber. As an example, the inlet port 88 may be located substantially in a center region 92 of the top portion 90. As another example, the inlet port 88 may be located substantially in a side region 94 of the top portion 90. As yet another example, the inlet port 88 may be located tangential to the side wall of the vacuum chamber, as shown in FIG. 4b. In some embodiments, the mixture may cascade down the side wall to an outlet port of the vacuum chamber.

In some embodiments, the inlet port 88 may be coupled to a nozzle, such as a nozzle of FIGS. 3a-3c. In some embodiments, the nozzle may be angled generally toward the outlet port of the vacuum chamber.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising:
receiving a mixture including milk and one or more gas additives at a milk processing system, the milk processing system including elements for processing milk;
heating the mixture;
directing the mixture toward an inlet operable to deliver a stream of the mixture into a vacuum chamber;
applying a negative vacuum pressure to the stream of the mixture as it is dispersed into the vacuum chamber, the negative vacuum pressure selected to substantially remove the added gas from the mixture; and
extracting the milk, with the added gas substantially removed, from the vacuum chamber.

2. The method of claim 1, wherein the mixture includes approximately 1700-2800 parts per million added gas.

3. The method of claim 1, wherein heating the mixture includes heating the mixture to a temperature in the range of approximately 130-175 degrees Fahrenheit.

4. The method of claim 1, wherein the mixture is delivered into the vacuum chamber at a rate of approximately 30-150 gallons per minute.

5. The method of claim 1, the delivering the stream of the mixture into the vacuum chamber further comprising dispersing the mixture using a nozzle operable to generate a cone shaped stream.

6. The method of claim 1, the delivering the stream of the mixture into the vacuum chamber further comprising dispersing the mixture using a nozzle operable to generate a parabolic shaped stream.

7. The method of claim 1, the delivering the stream of the mixture into the vacuum chamber further comprising dispersing the mixture using a nozzle operable to generate a fan shaped stream.

8. The method of claim 1, the delivering the stream of the mixture into the vacuum chamber further comprising cascading the stream down a side wall of the vacuum chamber.

9. The method of claim 1, wherein the negative vacuum pressure ranges from approximately 20-28 inches of mercury.

10. The method of claim 1, wherein the milk processing system includes a heat exchange system and further comprising sending the milk to a homogenizer and a pasteurization unit after the added carbon dioxide has been substantially removed.

11. The method of claim 1, wherein the mixture received by the milk processing system is formed by:
preparing a vessel with a head pressure of approximately 0 psig;
directing the gas and the milk to the vessel;
filling the vessel with the gas and the milk while maintaining a head pressure of approximately 25 psig or less;
decompressing the head pressure to approximately 0 psig after the vessel has been substantially filled; and
sealing the vessel.

12. The method of claim 1, wherein the mixture received by the milk processing system is formed by:
directing the gas and the milk to a vessel;
filling the vessel without head pressure; and
sealing the vessel.

13. The method of claim 1, wherein the directing the mixture toward the inlet includes directing a substantially continuous flow of the mixture toward the inlet.

14. The method of claim 1, wherein at least one of the one or more gas additives is selected from the group consisting of carbon dioxide, nitrogen, carbon monoxide, sulfur dioxide, ozone, and hydrogen.

15. A milk processing system, comprising:
a heater configured to heat a mixture including milk and one or more gas additives; and
a vacuum chamber configured to:
receive a stream of the heated mixture from an inlet;
apply a negative vacuum pressure to the stream of the mixture; and
substantially remove the gas from the mixture.

16. The milk processing system of claim 15, further comprising:
the heater operable to heat the mixture to a temperature in the range of approximately 130-175 degrees Fahrenheit;
the vacuum chamber operable to apply a negative vacuum pressure in the range of approximately 20-28 inches Hg; and
the inlet operable to disperse the stream of the mixture received by the vacuum chamber by cascading the mixture down a side wall of the vacuum chamber or directing the stream to a nozzle operable to generate a cone shaped, parabolic shaped, or a fan shaped stream.

17. The milk processing system of claim 15, wherein:
the mixture includes approximately 1700-2800 parts per million gas additives.

18. The milk processing system of claim 15, wherein:
the vacuum chamber receives approximately 30-150 gallons of the mixture per minute.

19. The milk processing system of claim 15, further including:
a balance tank for controlling a supply of milk to other elements of the milk processing system;
a vacuum pump for generating negative vacuum pressure in the vacuum chamber;
an extractor pump for extracting the milk, with the gas additive substantially removed, from the vacuum chamber;
a milk separator for separating the milk into skim milk and cream;
a homogenizer configured to shear the milk particles for even dispersion in the milk; and
a pasteurization unit for pasteurizing the milk to slow microbial growth.

20. The milk processing system of claim 15, wherein the heater includes a plate heat exchanger configured to heat the mixture to a temperature in the range of approximately 130-175 degrees Fahrenheit

21. The milk processing system of claim 15, further including:
a vacuum pump for generating negative vacuum pressure in the vacuum chamber, the negative vacuum pressure in the range of approximately 20 to 28 inches Hg.

22. The milk processing system of claim 15, wherein the vacuum chamber receives a substantially continuous flow of the mixture from the inlet.

23. The milk processing system of claim 15, wherein at least one of the one or more gas additives is selected from the group consisting of carbon dioxide, nitrogen, carbon monoxide, sulfur dioxide, ozone, and hydrogen.
